(19) United States
(12) Patent Application Publication
(10) Pub. No.: US 2021/0305639 A1
(43) Pub. Date: Sep. 30, 2021

(54) GRAPHITIC FILM-ENABLED BATTERY COOLING SYSTEM AND METHOD OF OPERATING SAME

(71) Applicant: Global Graphene Group, Inc., Dayton, OH (US)

(72) Inventors: Aruna Zhamu, Springboro, OH (US); Bor Z. Jang, Centerville, OH (US)

(21) Appl. No.: 16/833,616

(22) Filed: Mar. 29, 2020

(51) Int. Cl. H01M 10/653; H01M 10/613; H01M 10/655; F28F 21/02

(52) U.S. Cl. CPC H01M 10/653; F28F 21/02; H01M 10/655; H01M 10/613

(57) ABSTRACT

Provided is a cooling system for a battery module or pack comprising one or a plurality of battery cells, the system comprising a graphitic heat spreader element configured to be in thermal communication with the battery cells; and a cooling mechanism or device in thermal communication with the graphitic heat spreader element and configured to transport heat generated from the battery cells through the graphitic heat spreader element to the cooling mechanism or device when the battery cell is discharged. The graphitic heat spreader element may comprise a graphitic film selected from a flexible graphite sheet or an artificial graphite film obtained from carbonization and graphitization of a carbon precursor film.

### FIELD

The present disclosure relates generally to the field of batteries and, in particular, to the cooling systems for rechargeable batteries.

### BACKGROUND

Electric vehicles (EVs) are viewed as a promising solution to CO₂ emission and climate change issues. Batteries have been at the heart of the rapidly emerging EV industry. The service life, capacity, and internal resistance of various types of rechargeable batteries, particularly the lithium-ion battery, are sensitive to temperature changes.

One major problem is the danger of overheating, allowing a large amount of current to reach a location in an extremely short period of time, creating local hot spots that can significantly degrade or damage the various component materials (anode, cathode, separator, and electrolyte, etc.) of a battery cell. Under extreme conditions, the local heat may cause the liquid electrolyte of a battery to catch fire, leading to fire and explosion hazards. Battery life may be reduced by ⅔ in hot climates during aggressive driving and without cooling. With a battery temperature exceeding the stable point, severe exothermic reactions can occur uncontrollably. In addition, if a lithium-ion battery approaches thermal runaway, only 12% of the total heat released in the battery is enough to trigger thermal runaway in adjacent battery cells. This is the biggest risk during the use of lithium-ion batteries. In order not to compromise the service life of a battery, it is important to design a battery module with good heat dissipation performance.

More commonly used battery thermal management methods include air cooling, liquid cooling, and phase change material (PCM) cooling, Air cooling can meet the thermal management requirements of the vehicles under some ordinary conditions. However, when the EV accelerates or operates at a high velocity, the battery is discharged at a high rate, generating heat at a fast pace. Under these conditions, conventional air cooling is unable to meet the cooling requirements for electric vehicles.

Phase change material (PCM) cooling system controls the temperature of the battery module by the heat absorption and heat release when the material undergoes phase changes. Power battery cooling experiments using PCM are easier to meet the needs of the lithium battery cooling system, but the high costs have prevented more widespread use of PCMs in electric vehicles.

The liquid cooling system can exhibit higher cooling efficiency and reliability. The liquid cooling system requires good sealing and fluid pumping accessories. The cooling performance of lithium-ion pouch or prismatic cells may be improved with cold plates implemented along both surfaces of a cell and by changing the inlet coolant mass flow rates and the inlet coolant temperatures. The enhanced cooling energy efficiency can be achieved with a low inlet coolant temperature, low inlet coolant mass flow rate, and a high number of the cooling channels.

Numerous methods have been proposed to improve the cooling performance. For air or liquid cooling, for example, increasing the coolant velocity or the size of cooling structure may benefit the average temperature and temperature uniformity. However, such improvements increase the pack volume and weight, resulting in a larger power consumption of the battery thermal management system (BTMS).

Overheating or thermal runaway of a battery, leading to the battery catching fire or battery explosion, has been a serious barrier against the acceptance of battery-driven EVs. There has been no effective approach to overcoming this battery safety problem without adding significant weight, volume, and complexity of the thermal management system. An urgent need exists for a battery system that can be operated in a safe mode free from any thermal runaway problem.

An object of the present disclosure is to provide a cooling system that enables the battery module/pack to operate in a safe mode with reduced or eliminated chance of overheating and without significantly increasing cooling system weight, volume, and complexity. Another object of the disclosure is to provide a method of operating such a cooling system and apparatus.

### SUMMARY

It may be noted that the word “electrode” herein refers to either an anode (negative electrode) or a cathode (positive electrode) of a battery. These definitions are also commonly accepted in the art of batteries or electrochemistry. In battery industry, a module comprises a plurality of battery cells packaged together. A pack comprises a plurality of modules aggregated together. The presently disclosed cooling system can be used to cool one or a plurality of battery cells, regardless if or not they are packed into a module or pack or simply some individual battery cells. The term “battery” can refer to a battery cell or several battery cells assembled or connected together.

The present disclosure provides a cooling system for a battery module or pack (comprising one or a plurality of battery cells), wherein the system comprises (a) a graphitic heat spreader element or member (preferably in the form of a film, sheet, layer, belt, band, etc.) configured to be in thermal communication with the battery cells (e.g. to abut or contact at least one of the battery cells or in contact with a thermal interface material which, in turn, in thermal contact with at least one of battery cells); and (b) a cooling mechanism or device in thermal communication with the heat spreader element and configured to transport heat generated by the battery cell(s) through the heat spreader element to the cooling mechanism or device when the battery cell is operated (e.g. discharged).

The cooling system may preferably further comprise a thermal interface material (TIM) coupled to at least one of the battery cells and the heat spreader element.

In certain embodiments, the graphitic heat spreader element is in a form of a graphitic film, sheet, layer, belt, or band having a thickness from about 100 nm to 10 mm (preferably from 1 μm to 2 mm and further preferably from 10 μm to 500 μm).

In certain embodiments, the graphitic heat spreader element has a thermal conductivity no less than 200 W/mK, preferably no less than 500 W/mK, further preferably no less than 1,000 W/mK, still further preferably no less than 1,200 W/mK, and most preferably no less than 1,500 W/mK (up to 1,750 W/mK).

In some embodiments, the graphitic heat spreader element comprises a graphitic film selected from a flexible graphite sheet, an artificial graphite film (or pyrolytic graphite film) obtained from carbonization and graphitization of a carbon precursor film (e.g. a pitch film or polymer film), or a combination thereof. Certain pitch films (e.g. meso-phase pitch) and polymer films (e.g. phenolic resin and polyimide films) can be carbonized and graphitized, yielding graphitic films that have a high carbon yield.

The carbon precursor polymer may be preferably selected from the group consisting of polyimide, polyamide, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, phenolic resin, composites thereof (containing graphene sheets and/or graphite flakes dispersed in the carbon precursor film), and combinations thereof. These polymers are found to have a high carbon yield when they are carbonized and/or graphitized.

The thermal interface material may comprise a material selected from graphene sheets, graphene foam, graphene-containing paste, graphite flake-containing paste, graphene-containing composite (e.g. graphene sheets dispersed in a plastic or rubber matrix), graphite flake-containing composite, flexible graphite sheet, artificial graphite film, particles of Ag, Ag, Cu, Al, brass, steel, Ti, Ni, Mg alloy, silicon nitride, boron nitride, aluminum nitride, boron arsenide, a composite thereof, or a combination thereof.

Preferably, the thermal interface material is electrically insulating and thermally conducting, having a thermal conductivity no less than 1 W/mK (preferably no less than 5 W/mK and further preferably no less than 10 W/mK). Although graphene sheets and expanded graphite flakes individually are electrically conducting, by dispersing graphene sheets and expanded graphite flakes in a plastic or rubber matrix one can obtain a composite that is electrically insulating and thermally conductive. The resulting graphene- or expanded graphite-reinforced polymer composite can be made to exhibit a thermal conductivity greater than 1 W/mK, typically up to 10 W/mK.

In certain preferred embodiments, the thermal interface material comprises a graphene foam having a thermal conductivity from 0.1 W/mK to 100 W/mK (preferably >1 W/mK and more preferably >10 W/mK) and the graphitic heat spreader element comprises a graphitic film having a thermal conductivity from 600 W/mK to 1,750 W/mK.

The cooling mechanism or device is designed to cool down a battery cell or multiple battery cells in a module or pack when the battery is discharged (e.g. when the cell(s) are operated to power an electronic device or EV motor). The heat generated by a cell is transported, preferably through a thermal interface material, to the heat spreader element, which transports the heat to the cooling mechanism or device.

The cooling mechanism or device is preferably selected from a heat sink, a heat pipe, a vapor chamber, a stream of flowing fluid (when an EV is in motion, air may be directed to flow into contact with the heat spreader tabs, for instance), a bath of a coolant fluid, a thermoelectric device, a cooled plate, a heat exchanger, a radiator, or a combination thereof.

In certain embodiments, the heat-spreader element comprises a high thermal conductivity material having a thermal conductivity no less than 10 W/mK. Preferably, the heat-spreader element comprises a material selected from a graphitic film (e.g. composed of expanded graphite flakes or graphite worms recompressed and/or aggregated together or bonded together into a film or sheet form).

In certain embodiments, the heat-spreader element has a heat-spreading area in contact with at least one of the six surfaces of a rectangular-shape battery cell. In this application, the heat spreader element is preferably flat and has a large heat-spreading area having a length-to-thickness ratio greater than 10, preferably greater than 50, more preferably greater than 100, and further more preferably greater than 500. The heat-spreader element typically has a thickness from about 0.5 μm to about 1 mm, but can be as thin as 10 nm and as thick as several centimeters.

In the cooling system, the heat spreader element may be configured to form multiple loading sites (pores) for accommodating individual battery cells. In some embodiments, the lodging sites comprise cylindrical pores to accommodate cylindrical-shape battery cells or rectangular pores to accommodate rectangular-shape battery cells.

The battery module may contain a battery cell selected from a lithium-ion battery, lithium metal secondary battery, lithium-sulfur battery, lithium-air battery, lithium-selenium battery, sodium-ion battery, sodium metal secondary battery, sodium-sulfur battery, sodium-air battery, magnesium-ion battery, magnesium metal battery, aluminum-ion battery, aluminum metal secondary battery, zinc-ion battery, zinc metal battery, zinc-air battery, nickel metal hydride battery, lead acid battery, lead acid-carbon battery, lead acid-based ultra-battery, lithium-ion capacitor, or supercapacitor cell.

The present disclosure also provides a method of operating a battery cooling system, the method comprising: (a) bringing a graphitic heat spreader element (member) to be in thermal contact with one or a plurality of battery cells in a module or pack and to receive heat from the battery cells; and (b) directing the heat to transport through the graphitic heat spreader element to a cooling mechanism or device which acts to remove the heat and keeps the battery temperature at or below a desired temperature.

In certain embodiments, a thermal interface material (TIM) is disposed between a surface of a battery cell (e.g. one of the 6 surfaces of a rectangular cell or the cylindrical surface of a cylindrical cell) and the heat spreader element. The TIM ensures good thermal contact between a battery cell and a graphitic heat spreader element and, thereby, reduces the interfacial resistance.

The thermal interface material preferably comprises a material selected from graphene sheets, graphene foam, graphene-containing paste, graphene-containing polymer composite, flexible graphite sheet, artificial graphite film, particles of graphite, Ag, Ag, Cu, Al, brass, steel, Ti, Ni, Mg alloy, silicon nitride, boron nitride, aluminum nitride, boron arsenide, a composite thereof, or a combination thereof.

The graphitic heat spreader element preferably has a thermal conductivity from 10 W/mK to 1,750 W/mK. The graphitic heat spreader element preferably comprises a graphitic film selected from a flexible graphite sheet, an artificial (pyrolytic) graphite film obtained from carbonization and graphitization of a carbon precursor film (e.g. a pitch film or polymer film), or a combination thereof.

The cooling mechanism or device may be selected from a heat sink, a heat pipe, a vapor chamber, a stream of flowing fluid, a bath of a coolant fluid, a thermoelectric device, a cooled plate (cold plate), a heat exchanger, a radiator, or a combination thereof.

### BRIEF DESCRIPTION OF THE DRAWINGS

FIG. 1(A) Schematic of a battery cooling system according to an embodiment of the present disclosure; multiple battery cells may be thermally attached to one primary surface or two primary surfaces of a graphitic heat spreader element (e.g. a graphitic film).

FIG. 1(B) Schematic of a battery cooling system according to another embodiment of the present disclosure; a thermal interface material provides intimate thermal contact between a battery cell and a graphitic heat spreader element, which is, in turn, thermally connected to a heat sink.

FIG. 1(C) Schematic of a disclosed battery cooling system that comprises a continuous graphitic belt (a graphitic heat spreader element or member) in thermal contact with multiple battery cells through a thin layer of a thermal interface material. The graphitic heat spreader element is in thermal communication with a cooling mechanism/ device.

FIG. 1(D) Schematic of a battery cooling system, according to an embodiment of the present disclosure. The cooling system comprises multiple cylindrical pores having pore walls composed of graphitic thermal films or expanded graphite composites as a graphitic heat spreader element.

FIG. 1(E) Schematic of a battery cooling system according to another embodiment of the present disclosure; a thermal interface material provides intimate thermal contact between a battery cell and a graphitic heat spreader element, which is, in turn, thermally connected to a cooling device.

FIG. 2(A) Schematic drawing illustrating the processes for producing intercalated and/or oxidized graphite, subsequently exfoliated graphite worms, and conventional paper, mat, film, and membrane of simply aggregated graphite or graphene flakes/platelets;

FIG.2(B) An SEM image of exfoliated carbon (exfoliated carbon worms);

FIG. 2(C) Another SEM image of graphite worms;

FIG. 2(D) Schematic drawing illustrating the approaches of producing thermally expanded/exfoliated graphite structures.

FIG. 3 Thermal conductivity values of a series of graphitic films derived from graphene-PI films (66% graphene+34% PI), graphene paper alone, and PI film alone prepared at various final heat treatment temperatures.

### DETAILED DESCRIPTION OF PREFERRED EMBODIMENTS

The present discussion of preferred embodiments makes use of lithium-ion battery as an example. The present disclosure is applicable to a wide array of rechargeable batteries, not limited to the lithium-ion batteries. Examples of the rechargeable batteries include the lithium-ion battery, lithium metal secondary battery, lithium-sulfur battery, lithium-air battery, lithium-selenium battery, sodium-ion battery, sodium metal secondary battery, sodium-sulfur battery, sodium-air battery, magnesium-ion battery, magnesium metal battery, aluminum-ion battery, aluminum metal secondary battery, zinc-ion battery, zinc metal battery, zinc-air battery, nickel metal hydride battery, lead acid battery, lead acid-carbon battery, lead acid-based ultra-battery, lithium-ion capacitor, and supercapacitor.

Battery thermal management (BTM) systems can be divided into two groups: active BTM systems and passive BTM systems. An active BTM system dissipates the heat generated from batteries by circulating the cooling air or coolant around the batteries. This system generally needs a power-consuming device, such as a pump or a cooling fan, to circulate the cooling medium. An active BTM system is efficient in managing the battery temperature, but it consumes part of the battery energy and adds complexities to the system.

In contrast, a passive BTM system absorbs the heat generated from batteries by filling cooling materials with high specific heat (e.g. water/glycol mixture) in between batteries. A passive BTM system may also make use of a phase change material (PCM). Amongst the drawbacks of passive BTM systems is that the addition of the cooling material increases the weight of the battery system and reduces the volume of active charge storing material, thus reducing the specific energy of the battery system. Accordingly, there is a drive to use the minimum amount of cooling material to achieve the best cooling effect and minimal reduction in the specific energy of a secondary battery.

The present disclosure provides a cooling system for a battery module (comprising one or a plurality of battery cells), wherein the system comprises (a) a graphitic heat spreader element (preferably in the form of a graphitic film, sheet, layer, belt, band, etc.) configured to be in thermal communication with the battery cells (e.g. to abut or contact at least one of the battery cells or in contact with a thermal interface material which is, in turn, in thermal contact with at least one of the battery cells); and (b) a cooling mechanism or device in thermal communication with the graphitic heat spreader element and configured to transport heat generated by the battery cell(s) through the heat spreader element into a cooling mechanism or device.

Due to the high thermal conductivity of the graphitic film, such implementation of a graphitic heat spreader member can rapidly transport the heat out of the battery cells, reducing or eliminating the need to have complex, bulky or heavy cooling apparatus. The disclosed cooling system per se can be a passive cooling system or part of an active cooling system.

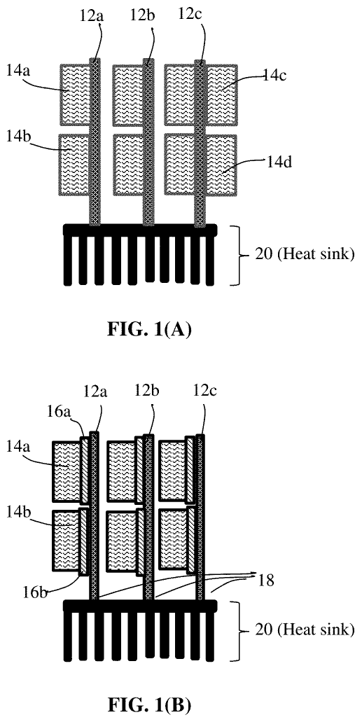

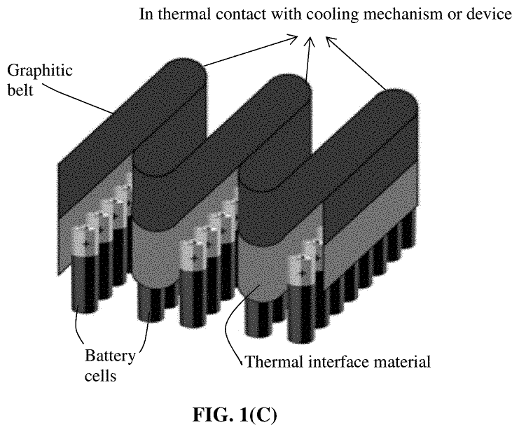

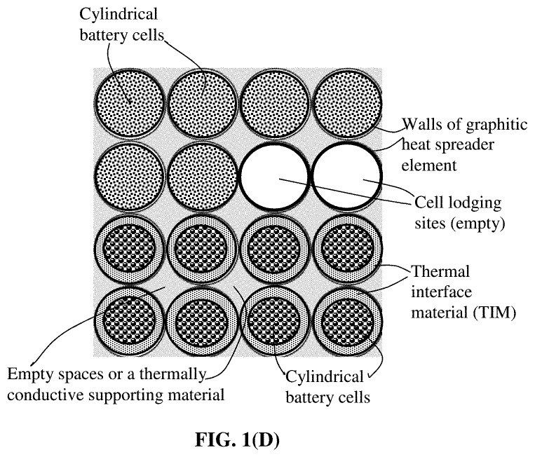

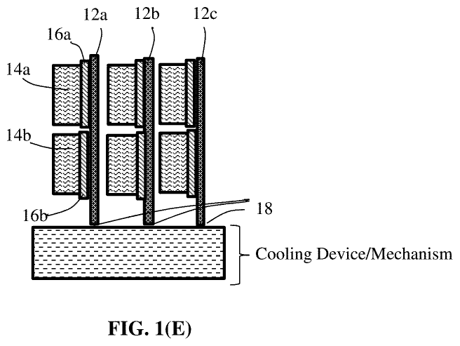

As illustrated in FIG. 1(A), according to some embodiments of the disclosure, the battery cells (e.g. 14a, 14b, 14c, 14d) are in thermal or physical contact with a graphitic heat spreader element (e.g. containing graphitic films 12a, 12b, or 12c), which is, in turn, in thermal or physical contact with a cooling mechanism or device (e.g. a heat sink 20, vapor chamber, or cooled plate). The heat generated by a battery cell during cell discharging is transferred to a graphitic thermal film which rapidly spreads the heat over to a cooling mechanism or device (e.g., a finned heat sink 20 in FIG. 1(A) or alternatively shown in FIG. 1(E)). The heat spreading rate in the graphitic heat spreader element can be exceptionally high due to the high thermal conductivity of graphitic films.

The cooling system may preferably further comprise a thermal interface material (TIM) coupled to at least one of the battery cells and the heat spreader element. As illustrated in FIG. 1(B), a TIM (e.g. 16a or 16b) is implemented between a battery cell (e.g. 14a or 14b) and a graphene heat spreader element (e.g. 12a). The presence of a TIM enables a good thermal contact between a heat spreader element and a battery cell (a heat source). Illustrated in FIG.1 (B) the thermal interface portion 18 of the heat sink 20 is in thermal contact with the heat spreader element 12b. The heat sink 20 also includes a cooling portion, which in this case includes a set of cooling fins.

Illustrated in FIG. 1(C) is portion of a disclosed battery cooling system that comprises a continuous graphitic belt (a graphitic heat spreader element or member). The continuous graphitic belt runs through the gaps between rows (or modules) of battery cells. A thermal interface material (e.g. a graphene- or expanded graphite-reinforced rubber matrix composite or graphene foam) is disposed between the battery cells and the graphitic heat spreader element. Heat generated from battery cells is transported through the thermal interface material into the graphitic heat spreader element. Due to the exceptionally high thermal conductivity of the graphitic material, heat can rapidly spread from the battery cell contact points to a far end or other portion of the heat spreader element where the heat spreader is in thermal communication with a cooling mechanism/device (e.g. a liquid coolant bath, a stream of flowing air, a heat pipe, a finned heat sink, a radiator, a heat sink, a vapor chamber, a stream of flowing fluid, a bath of a coolant fluid, a thermoelectric device, a heat exchanger, a cooled plate, etc.). Heat is then rapidly dissipated or removed by the cooling mechanism/device, which can be in thermal contact with the graphitic belt at one or multiple interfaces.

Schematically shown in FIG. 1(D) is a battery cooling system, according to an embodiment of the present disclosure. The battery pack equipped with such a cooling system may be disposed in the chassis of an electric vehicle. In certain embodiments, the cooling system comprises multiple cylindrical pores having pore walls constituted by graphitic thermal films (graphitic heat spreader element). Cylindrical battery cells may be directly fit into the pores (the cell-lodging sites), as illustrated in the upper two rows of FIG. 1(D). There can be a cylindrical shell of a TIM disposed between the graphitic heat spreader element wall and a cylindrical battery cell, as illustrated in the lower two rows of FIG. 1(D). It may be noted that the cell-lodging pores do not have to be cylindrical in shape and can be of any shape conformal to the actual battery cell shape. The graphitic heat spreader element is in thermal communication with a cooling mechanism or device (shown in FIG. 1(E)). For instance, the opposite ends of heat spreader element may be connected to a heat sink (e.g. attached to a finned heat sink, being immersed in a coolant bath, subjected to a stream of blowing air, etc.). When the battery cells in the pack are discharged to drive the EV, the cooling system keeps the battery lower than a safe temperature.

There is no limitation on the type of cooling mechanism or device that can be implemented to cool down the battery cells when working to power an electronic device or an EV. The cooling mechanism or device may be selected from a heat sink, a heat pipe, a vapor chamber, a stream of flowing fluid, a thermoelectric device, a cooled/refrigerated plate, a heat exchanger, a radiator, or a combination thereof.

It is important that the heat spreader element has a high thermal conductivity to allow for rapid transfer of a large amount of heat from the battery surface through the heat spreader element to a cooling mechanism or device when the cell is discharged.

In certain embodiments, the heat-spreader element comprises a high thermal conductivity material having a thermal conductivity no less than 10 W/mK (preferably no less than 200 W/mK, further preferably greater than 600 W/mK, more preferably greater than 1,000 W/mK, and most preferably greater than 1,500 W/mK). Preferably, the heat-spreader element comprises a graphitic film (e.g. composed of flexible graphite sheet or polyimide-derived artificial graphite film0, typically having a thermal conductivity of 200-500 W/mK (flexible graphite sheet) or 800-1,750 W/mK (artificial graphite film) and a thickness from 10 nm to 5 mm).

The thermal interface material may comprise a material selected from graphene sheets, graphene foam, graphene-containing paste, graphene-containing polymer composite, flexible graphite sheet, artificial graphite film, particles of graphite, Ag, Ag, Cu, Al, brass, steel, Ti, Ni, Mg alloy, silicon nitride, boron nitride, aluminum nitride, boron arsenide, a composite thereof, or a combination thereof. Thermal interface materials are well-known in the art.

Graphene films, flexible graphite sheets, and artificial graphite films are commonly regarded as three fundamentally different and patently distinct classes of materials.

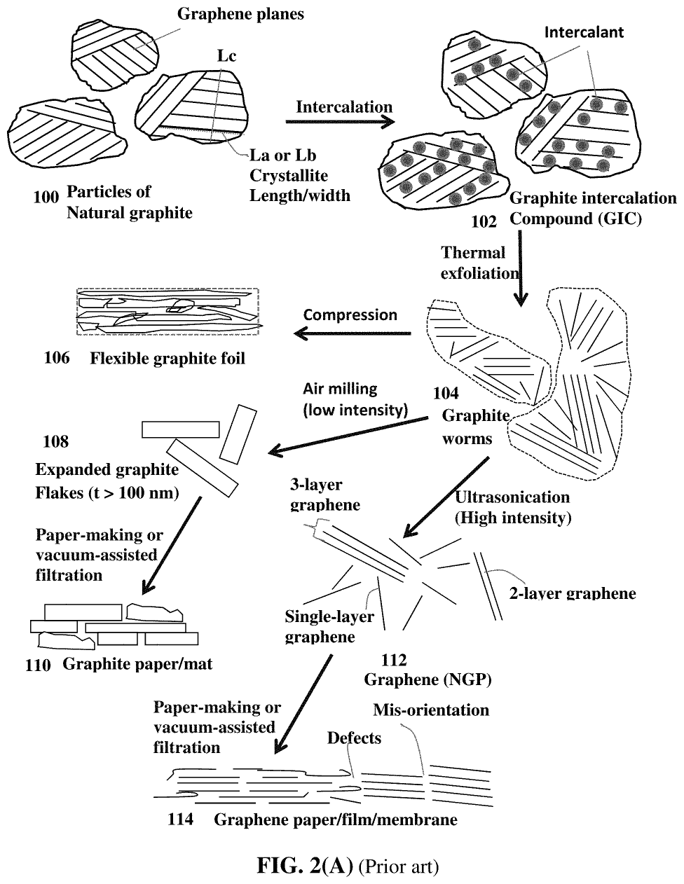

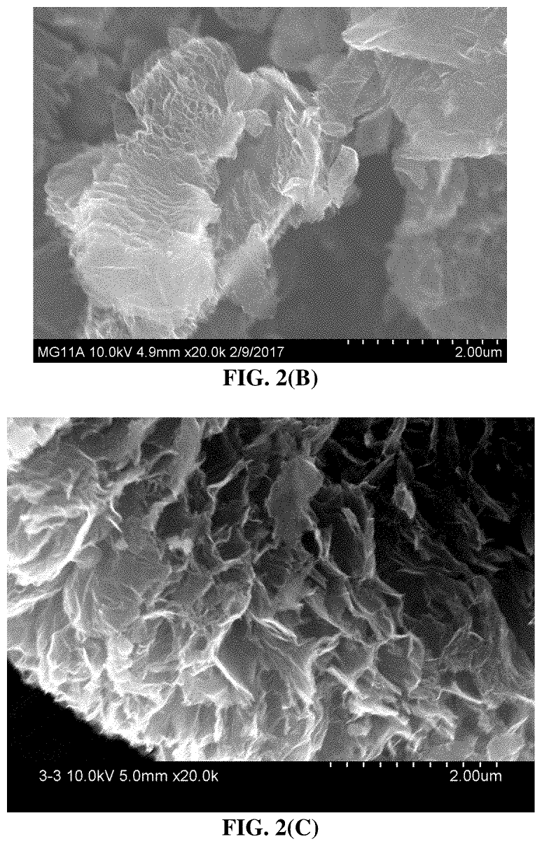

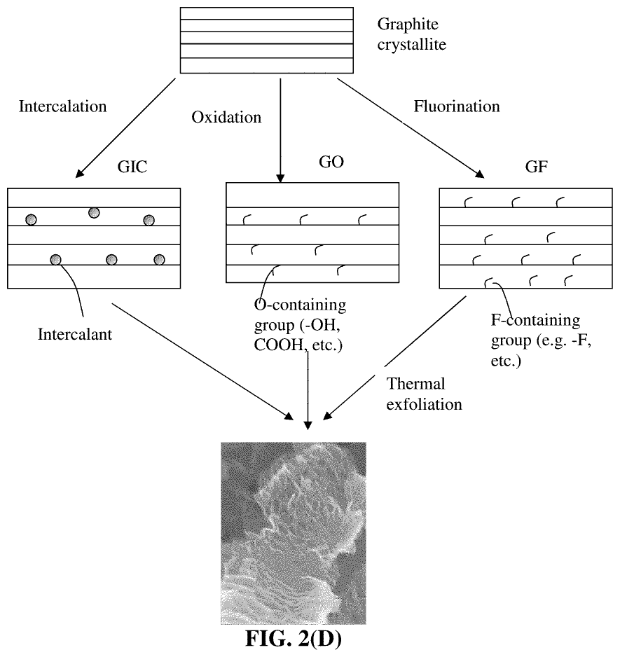

As schematically illustrated in the upper portion of FIG.2(A), bulk natural graphite is a 3-D graphitic material with each graphite particle being composed of multiple grains (a grain being a graphite single crystal or crystallite) with grain boundaries (amorphous or defect zones) demarcating neighboring graphite single crystals. Each grain is composed of multiple graphene planes that are oriented parallel to one another. A graphene plane or hexagonal carbon atom plane in a graphite crystallite is composed of carbon atoms occupying a two-dimensional, hexagonal lattice. In a given grain or single crystal, the graphene planes are stacked and bonded via van der Waal forces in the crystallographic c-direction (perpendicular to the graphene plane or basal plane). The inter-graphene plane spacing in a natural graphite material is approximately 0.3354 nm.

Artificial graphite materials also contain constituent graphene planes, but they have an inter-graphene planar spacing, d₀₀₂, typically from 0.32 nm to 0.36 nm (more typically from 0.3339 to 0.3465 nm), as measured by X-ray diffraction. Many carbon or quasi-graphite materials also contain graphite crystals (also referred to as graphite crystallites, domains, or crystal grains) that are each composed of stacked graphene planes. These include meso-carbon micro-beads (MCMBs), meso-phase carbon, soft carbon, hard carbon, coke (e.g. needle coke), carbon or graphite fibers (including vapor-grown carbon nano-fibers or graphite nano-fibers), and multi-walled carbon nanotubes (MW-CNT). The spacing between two graphene rings or walls in a MW-CNT is approximately 0.27 to 0.42 nm. The most common spacing values in MW-CNTs are in the range from 0.32-0.35 nm, which do not strongly depend on the synthesis method.

It may be noted that the “soft carbon” refers to a carbon material containing graphite domains wherein the orientation of the hexagonal carbon planes (or graphene planes) in one domain and the orientation in neighboring graphite domains are not too mis-matched from each other so that these domains can be readily merged together when heated to a temperature above 2,000° C. (more typically above 2,500° C.). Such a heat treatment is commonly referred to as graphitization. Thus, the soft carbon can be defined as a carbonaceous material that can be graphitized. In contrast, a “hard carbon” can be defined as a carbonaceous material that contain highly mis-oriented graphite domains that cannot be thermally merged together to obtain larger domains; i.e. the hard carbon cannot be graphitized.

The spacing between constituent graphene planes of a graphite crystallite in a natural graphite, artificial graphite, and other graphitic carbon materials in the above list can be expanded (i.e. the d₀₀₂ spacing being increased from the original range of 0.27-0.42 nm to the range of 0.42-2.0 nm) using several expansion treatment approaches, including oxidation, fluorination, chlorination, bromination, iodization, nitrogenation, intercalation, combined oxidation-intercalation, combined fluorination-intercalation, combined chlorination-intercalation, combined bromination-intercalation, combined iodization-intercalation, or combined nitrogenation-intercalation of the graphite or carbon material.

More specifically, due to the van der Waals forces holding the parallel graphene planes together being relatively weak, natural graphite can be treated so that the spacing between the graphene planes can be increased to provide a marked expansion in the c-axis direction. This results in a graphite material having an expanded spacing, but the laminar character of the hexagonal carbon layers is substantially retained. The inter-planar spacing (also referred to as inter-graphene spacing) of graphite crystallites can be increased (expanded) via several approaches, including oxidation, fluorination, and/or intercalation of graphite. This is schematically illustrated in FIG. 2(D). The presence of an intercalant, oxygen-containing group, or fluorine-containing group serves to increase the spacing between two graphene planes in a graphite crystallite.

The inter-planar spaces between certain graphene planes may be significantly increased (actually, exfoliated) if the graphite/carbon material having expanded d spacing is exposed to a thermal shock (e.g. by rapidly placing this carbon material in a furnace pre-set at a temperature of typically 800-2,500° C.) without constraint (i.e. being allowed to freely increase volume). Under these conditions, the thermally exfoliated graphite/carbon material appears like worms, wherein each graphite worm is composed of many graphite flakes remaining interconnected (please see FIG. 2(C)). However, these graphite flakes have inter-flake pores typically in the pore size range of 20 nm to 10 μm.

Alternatively, the intercalated, oxidized, or fluorinated graphite/carbon material having expanded d spacing may be exposed to a moderate temperature (100-800° C.) under a constant-volume condition for a sufficient length of time. The conditions may be adjusted to obtain a product of limited exfoliation, having inter-flake pores of 2-20 nm in average size. This is herein referred to as a constrained expansion/exfoliation treatment. We have surprisingly observed that an A1 cell having a cathode of graphite/carbon having inter-planar spaces 2-20 nm is capable of delivering a high energy density, high power density, and long cycle life.

In one process, graphite materials having an expanded inter-planar spacing are obtained by intercalating natural graphite particles with a strong acid and/or an oxidizing agent to obtain a graphite intercalation compound (GIC) or graphite oxide (GO), as illustrated in FIG. 2(A). The presence of chemical species or functional groups in the interstitial spaces between graphene planes serves to increase the inter-graphene spacing, d₀₀₂, as determined by X-ray diffraction, thereby significantly reducing the van der Waals forces that otherwise hold graphene planes together along the c-axis direction. The GIC or GO is most often produced by immersing natural graphite powder (100 in FIG. 2(A)) in a mixture of sulfuric acid, nitric acid (an oxidizing agent), and another oxidizing agent (e.g. potassium permanganate or sodium perchlorate). The resulting GIC (102) is actually some type of graphite oxide (GO) particles if an oxidizing agent is present during the intercalation procedure. This GIC or GO is then repeatedly washed and rinsed in water to remove excess acids, resulting in a graphite oxide suspension or dispersion, which contains discrete and visually discernible graphite oxide particles dispersed in water.

Water may be removed from the suspension to obtain “expandable graphite,” which is essentially a mass of dried GIC or dried graphite oxide particles. The inter-graphene spacing, d₀₀₂, in the dried GIC or graphite oxide particles is typically in the range from 0.42-2.0 nm, more typically in the range from 0.5-1.2 nm. It may be noted than the “expandable graphite” is not “expanded graphite” (to be further explained later).

Upon exposure of expandable graphite to a temperature in the range from typically 800-2,500° C. (more typically 900-1,050° C.) for approximately 30 seconds to 2 minutes, the GIC undergoes a rapid volume expansion by a factor of 30-300 to form “exfoliated graphite” or “graphite worms” (104), Graphite worms are each a collection of exfoliated, but largely un-separated graphite flakes that remain interconnected (FIG. 2(B) and 2(C)). In exfoliated graphite, individual graphite flakes (each containing 1 to several hundred of graphene planes stacked together) are highly spaced from one another, having a spacing of typically 2.0 nm-10 μm. However, they remain physically interconnected, forming an accordion or worm-like structure.

In graphite industry, graphite worms can be re-compressed to obtain flexible graphite sheets or foils (106) that typically have a thickness in the range from 0.1 mm (100 μm)-0.5 mm (500 μm). Such flexible graphite sheets may be used as a type of graphitic heat spreader element.

Alternatively, in graphite industry, one may choose to use a low-intensity air mill or shearing machine to simply break up the graphite worms for the purpose of producing the so-called “expanded graphite” flakes (108) which contain mostly graphite flakes or platelets thicker than 100 nm (hence, not a nano material by definition). It is clear that the “expanded graphite” is not “expandable graphite” and is not “exfoliated graphite worm” either. Rather, the “expandable graphite” can be thermally exfoliated to obtain “graphite worms,” which, in turn, can be subjected to mechanical shearing to break up the otherwise interconnected graphite flakes to obtain “expanded graphite” flakes. Expanded graphite flakes typically have the same or similar inter-planar spacing (typically 0.335-0.36 nm) of their original graphite. Multiple expended graphite flakes may be roll-pressed together to form graphitic films, which are a variation of flexible graphite sheets.

Alternatively, the exfoliated graphite or graphite worms may be subjected to high-intensity mechanical shearing (e.g. using an ultrasonicator, high-shear mixer, high-intensity air jet mill, or high-energy ball mill) to form separated single-layer and multi-layer graphene sheets (collectively called NGPs, 112), as disclosed in our U.S. application Ser. No. 10/858,814 (U.S. Pat. Pub. No 2005/0271574) (now abandoned). Single-layer graphene can be as thin as 0.34 nm, while multi-layer graphene can have a thickness up to 100 nm, but more typically less than 3 nm (commonly referred to as few-layer graphene). Multiple graphene sheets or platelets may be made into a sheet of NGP paper (114) using a paper-making process.

In GIC or graphite oxide, the inter-graphene plane separation has been increased from 0.3354 nm in natural graphite to 0.5-1.2 nm in highly oxidized graphite oxide, significantly weakening the van der Waals forces that hold neighboring planes together. Graphite oxide can have an oxygen content of 2%-50% by weight, more typically 20%-40% by weight. GIC or graphite oxide may be subjected to a special treatment herein referred to as “constrained thermal expansion”. If GIC or graphite oxide is exposed to a thermal shock in a furnace (e.g. at 800-1,050° C.) and allowed to freely expand, the final product is exfoliated graphite worms. However, if the mass of GIC or graphite oxide is subjected to a constrained condition (e.g. being confined in an autoclave under a constant volume condition or under a uniaxial compression in a mold) while being slowly heated from 150° C. to 800° C. (more typically up to 600°) for a sufficient length of time (typically 2 minutes to 15 minutes), the extent of expansion can be constrained and controlled, and the product can have inter-flake spaces from 2.0 nm to 20 nm, or more desirably from 2 nm to 10 nm.

It may be noted that the “expandable graphite” or graphite with expanded inter-planar spacing may also be obtained by forming graphite fluoride (GF), instead of GO. Interaction of F₂ with graphite in a fluorine gas at high temperature leads to covalent graphite fluorides, from (CF)ₙ to (C₂F)ₙ, while at low temperatures graphite intercalation compounds (GIC) CₓF (2≤x≤24) form. In (CF)ₙ carbon atoms are sp3-hybridized and thus the fluorocarbon layers are corrugated consisting of trans-linked cyclohexane chairs. In (C₂F)ₙ only half of the C atoms are fluorinated and every pair of the adjacent carbon sheets are linked together by covalent C—C bonds. Systematic studies on the fluorination reaction showed that the resulting F/C ratio is largely dependent on the fluorination temperature, the partial pressure of the fluorine in the fluorinating gas, and physical characteristics of the graphite precursor, including the degree of graphitization, particle size, and specific surface area. In addition to fluorine (F₂), other fluorinating agents (e.g. mixtures of F₂ with Br₂, Cl₂, or I₂) may be used, although most of the available literature involves fluorination with F₂ gas, sometimes in presence of fluorides.

We have observed that lightly fluorinated graphite, CₓF (2≤x≤24), obtained from electrochemical fluorination, typically has an inter-graphene spacing (d₀₀₂) less than 0.37 nm, more typically <0.35 nm. Only when x in CₓF is less than 2 (i.e. 0.5≤x≤2) can one observe a d₀₀₂ spacing greater than 0.5 nm (in fluorinated graphite produced by a gaseous phase fluorination or chemical fluorination procedure). When x in CₓF is less than 1.33 (i.e. 0.5≤x<1.33) one can observe a d₀₀₂ spacing greater than 0.6 nm. This heavily fluorinated graphite is obtained by fluorination at a high temperature (>>200° C.) for a sufficiently long time, preferably under a pressure >1 atm, and more preferably >3 atm. For reasons remaining unclear, electrochemical fluorination of graphite leads to a product having a d spacing less than 0.4 nm even though the product CₓF has an x value from 1 to 2. It is possible that F atoms electrochemically introduced into graphite tend to reside in defects, such as grain boundaries, instead of between graphene planes and, consequently, do not act to expand the inter-graphene planar spacing.

The nitrogenation of graphite can be conducted by exposing a graphite oxide material to ammonia at high temperatures (200-400° C.). Nitrogenation may also be conducted at lower temperatures by a hydrothermal method; e.g. by sealing GO and ammonia in an autoclave and then increased the temperature to 150-250° C.

In addition to N, O, F, Br, Cl, or H, the presence of other chemical species (e.g. Na, Li, K, Ce, Ca, Fe, NH₄, etc.) between graphene planes can also serve to expand the inter-planar spacing, creating room to accommodate electrochemically active materials therein. The expanded interstitial spaces between graphene planes (hexagonal carbon planes or basal planes) are found by us in this study to be surprisingly capable of accommodating Al⁺³ ions and other anions (derived from electrolyte ingredients) as well, particularly when the spaces are from 2.0 nm to 20 nm. It may be noted that graphite can electrochemically intercalated with such chemical species as Na, Li, K, Ce, Ca, NH₄, or their combinations, which can then be chemically or electrochemically ion-exchanged with metal elements (Bi, Fe, Co, Mn, Ni, Cu, etc.). All these chemical species can serve to expand the inter-planar spacing. The spacing may be dramatically expanded (exfoliated) to have inter-flake pores that are 20 nm-10 μm in size.

A second type of graphitic film for use as a graphitic heat spreader is a pyrolitic graphite film, also referred to as artificial graphite film, which is produced from a carbon precursor, such as a polymer film or pitch film. For instance, the process begins with carbonizing a polymer film at a carbonization temperature of 400-1,500° C. under a typical pressure of 10-15 kg/cm² for 2-10 hours to obtain a carbonized material, which is followed by a graphitization treatment at 2,500-3,200° C. under an ultrahigh pressure of 100-300 kg/cm² for 1-5 hours to form a graphitic film. The carbon precursor polymer may be preferably selected from the group consisting of polyimide, polyamide, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, phenolic resin, composites thereof (containing graphene sheets and/or graphite flakes dispersed in the carbon precursor film), and combinations thereof. These polymers are found to have a high carbon yield when they are carbonized and/or graphitized.

An example of this process is disclosed in Y. Nishikawa, et al. “Filmy graphite and process for producing the same,” U.S. Pat. No. 7,758,842 (Jul. 20, 2010) and in Y. Nishikawa, et al. “Process for producing graphite film,” U.S. Pat. No. 8,105,565 (Jan. 31, 2012).

One of the more desirable thermal interface materials for use in the presently disclosed battery cooling system is graphene foam. Generally speaking, a foam or foamed material is composed of pores (or cells) and pore walls (a solid material). The pores can be interconnected to form an open-cell foam. A graphene foam is composed of pores and pore walls that contain a graphene material. There are four major methods of producing graphene foams:

The first method is the hydrothermal reduction of graphene oxide hydrogel that typically involves sealing graphene oxide (GO) aqueous suspension in a high-pressure autoclave and heating the GO suspension under a high pressure (tens or hundreds of atm) at a temperature typically in the range from 180-300° C. for an extended period of time (typically 12-36 hours). A useful reference for this method is given here: Y. Xu, et al. “Self-Assembled Graphene Hydrogel via a One-Step Hydrothermal Process,” ACS Nano 2010, 4, 4324-4330.

The second method is based on a template-assisted catalytic CVD process, which involves CVD deposition of graphene on a sacrificial template (e.g. Ni foam). The graphene material conforms to the shape and dimensions of the Ni foam structure. The Ni foam is then etched away using an etching agent, leaving behind a monolith of graphene skeleton that is essentially an open-cell foam. A useful reference for this method is given here: Zongping Chen, et al., “Three-dimensional flexible and conductive interconnected graphene networks grown by chemical vapour deposition,” Nature Materials, 10 (Jun. 2011) 424-428.

The third method of producing graphene foam also makes use of a sacrificial material (e.g. colloidal polystyrene particles, PS) that is coated with graphene oxide sheets using a self-assembly approach. For instance, Choi, et al. prepared chemically modified graphene (CMG) paper in two steps: fabrication of free-standing PS/CMG films by vacuum filtration of a mixed aqueous colloidal suspension of CMG and PS (2.0 μm PS spheres), followed by removal of PS beads to generate 3D macro-pores. [B. G. Choi, et al., “3D Macroporous Graphene Frameworks for Supercapacitors with High Energy and Power Densities,” ACS Nano, 6 (2012) 4020-4028.] Choi, et al. fabricated well-ordered free-standing PS/CMG paper by filtration, which began with separately preparing a negatively charged CMG colloidal and a positively charged PS suspension. A mixture of CMG colloidal and PS suspension was dispersed in solution under controlled pH (=2), where the two compounds had the same surface charges (zeta potential values of +13±2.4 mV for CMG and +68±5.6 mV for PS). When the pH was raised to 6, CMGs (zeta potential=−29±3.7 mV) and PS spheres (zeta potential=+51±2.5 mV) were assembled due to the electrostatic interactions and hydrophobic characteristics between them, and these were subsequently integrated into PS/CMG composite paper through a filtering process.

The fourth method for producing a solid graphene foam composed of multiple pores and pore walls was invented by us earlier [Aruna Zhamu and Bor Z. Jang, “Highly Conductive Graphene Foams and Process for Producing Same,” U.S. patent application Ser. No. 14/120,959 (Jul. 17, 2014)]. The process comprises:

(a) preparing a graphene dispersion having a graphene material dispersed in a liquid medium, wherein the graphene material is selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof and wherein the dispersion contains an optional blowing agent;

(b) dispensing and depositing the graphene dispersion onto a surface of a supporting substrate (e.g. plastic film, rubber sheet, metal foil, glass sheet, paper sheet, etc.) to form a wet layer of graphene material, wherein the dispensing and depositing procedure includes subjecting the graphene dispersion to an orientation-inducing stress;

(c) partially or completely removing the liquid medium from the wet layer of graphene material to form a dried layer of graphene material having a content of non-carbon elements (e.g. O, H, N, B, F, Cl, Br, I, etc.) no less than 5% by weight; and

(d) heat treating the dried layer of graphene material at a first heat treatment temperature from 100° C. to 3,200° C. at a desired heating rate sufficient to induce volatile gas molecules from the non-carbon elements or to activate said blowing agent for producing the solid graphene foam having a density from 0.01 to 1.7 g/cm³ (more typically from 0.1 to 1.5 g/cm³, and even more typically from 0.1 to 1.0 g/cm³, and most typically from 0.2 to 0.75 g/cm³), or a specific surface area from 50 to 3,000 m²/g (more typically from 200 to 2,000 m²/g, and most typically from 500 to 1,500 m²/g).

This optional blowing agent is not required if the graphene material has a content of non-carbon elements (e.g. O, H, N, B, F, Cl, Br, I, etc.) no less than 5% by weight (preferably no less than 10%, further preferably no less than 20%, even more preferably no less than 30% or 40%, and most preferably up to 50%). The subsequent high temperature treatment serves to remove a majority of these non-carbon elements from the graphene material, generating volatile gas species that produce pores or cells in the solid graphene material structure. In other words, quite surprisingly, these non-carbon elements play the role of a blowing agent. Hence, an externally added blowing agent is optional (not required). However, the use of a blowing agent can provide added flexibility in regulating or adjusting the porosity level and pore sizes for a desired application. The blowing agent is typically required if the non-carbon element content is less than 5%, such as pristine graphene that is essentially all-carbon.

The graphene foam produced by the fourth method has the highest thermal conductivity among all graphene foam materials, and also exhibit a highly reversible and durable elastic deformation under tension or compression, enabling good, long-term contact between a heat spreader element and a battery cell surface.

The rechargeable battery that can take advantage of the presently disclosed cooling system may be a lithium-ion battery, lithium metal secondary battery, lithium-sulfur battery, lithium-air battery, lithium-selenium battery, sodium-ion battery, sodium metal secondary battery, sodium-sulfur battery, sodium-air battery, magnesium-ion battery, magnesium metal battery, aluminum-ion battery, aluminum metal secondary battery, zinc-ion battery, zinc metal battery, zinc-air battery, nickel metal hydride battery, lead acid battery, lead acid-carbon battery, lead acid-based ultra-battery, lithium-ion capacitor, or supercapacitor.

The following examples serve to provide the best modes of practice for the present disclosure and should not be construed as limiting the scope of the disclosure:

### EXAMPLE 1

### Production of Graphitic Films through Oxidation of Graphite, Thermal Expansion/Exfoliation of Oxidized Graphite, and Re-Compression of Exfoliated Graphite

Natural flake graphite, nominally sized at 45 μm, provided by Asbury Carbons (405 Old Main St., Asbury, N.J. 08802, USA) was milled to reduce the size to approximately 14 μm (Sample 1a). The chemicals used in the present study, including fuming nitric acid (>90%), sulfuric acid (95-98%), potassium chlorate (98%), and hydrochloric acid (37%), were purchased from Sigma-Aldrich and used as received. Graphite oxide (GO) samples were prepared according to the following procedure:

Sample 1A: A reaction flask containing a magnetic stir bar was charged with sulfuric acid (176 mL) and nitric acid (90 mL) and cooled by immersion in an ice bath. The acid mixture was stirred and allowed to cool for 15 min, and graphite (10 g) was added under vigorous stirring to avoid agglomeration. After the graphite powder was well dispersed, potassium chlorate (110 g) was added slowly over 15 min to avoid sudden increases in temperature. The reaction flask was loosely capped to allow evolution of gas from the reaction mixture, which was stirred for 24 hours at room temperature. On completion of the reaction, the mixture was poured into 8 L of deionized water and filtered. The GO was re-dispersed and washed in a 5% solution of HCl to remove sulfate ions. The filtrate was tested intermittently with barium chloride to determine if sulfate ions are present. The HCl washing step was repeated until this test was negative. The GO was then washed repeatedly with deionized water until the pH of the filtrate was neutral. The GO slurry was spray-dried and stored in a vacuum oven at 60° C. until use.

Two additional samples were also prepared: The same procedure as in Sample 1A was followed, but the reaction time was 48 hours, to obtain Sample 1B. For the preparation of Sample 1C, the same procedure as in Sample 1A was followed, but the reaction time was 96 hours.

X-ray diffraction studies showed that after a treatment of 24 hours, a significant proportion of graphite has been transformed into graphite oxide. The peak at 2θ=26.3 degrees, corresponding to an inter-planar spacing of 0.335 nm (3.35 Å) for pristine natural graphite was significantly reduced in intensity after a deep oxidation treatment for 24 hours and a peak typically near 2θ=9-14 degrees (depending upon degree of oxidation) appeared. In the present study, the curves for treatment times of 48 and 96 hours are essentially identical, showing that essentially all of the graphite crystals have been converted into graphite oxide with an inter-planar spacing of 6.5-7.5 Å (the 26.3 degree peak has totally disappeared and a peak of approximately at 2θ=11.75-13.7 degrees appeared).

Samples 1A, 1B, and 1C were then subjected to both free thermal exfoliation (1,050° C. for 2 minutes) and constrained thermal expansion/exfoliation (slowly heated from 100° C. to 450° C. in a span of 15 minutes) to obtain thermally exfoliated graphite worms having different ranges of inter-flake pore sizes between different samples.

Exfoliated graphite worms from Samples 1A, 1B, and 1C were then roll-pressed to obtain flexible graphite sheets having thickness values of 100 μm, 500 μm, and 1 mm.

### EXAMPLE 2

### Preparation of Graphite Oxide (GO) Using a Modified Hummers' Method

Graphite oxide (Sample 3A) was prepared by oxidation of natural graphite flakes with sulfuric acid, sodium nitrate, and potassium permanganate according to the method of Hummers [U.S. Pat. No. 2,798,878, Jul. 9, 1957]. In this example, for every 1 gram of graphite, we used a mixture of 22 ml of concentrated sulfuric acid, 2.8 grams of potassium permanganate, and 0.5 grams of sodium nitrate. The graphite flakes were immersed in the mixture solution and the reaction time was approximately one hour at 35.degree. C. It is important to caution that potassium permanganate should be gradually added to sulfuric acid in a well-controlled manner to avoid overheat and other safety issues. Upon completion of the reaction, the mixture was poured into deionized water and filtered. The sample was then washed repeatedly with deionized water until the pH of the filtrate was approximately 5. The slurry was spray-dried and stored in a vacuum oven at 60° C. for 24 hours. The interlayer spacing of the resulting laminar graphite oxide was determined by the Debye-Scherrer X-ray technique to be approximately 0.73 nm (7.3 Å). Some of the powder was subsequently exfoliated in a furnace, pre-set at 950-1,100° C., for 2 minutes to obtain thermally exfoliated graphite worms. Some of the graphite worms were compressed to obtain flexible graphite foil.

### EXAMPLE 3

### Oxidation of Meso-Carbon Micro-Beads (MCMBs)

Graphite oxide (Sample 3A) was prepared by oxidation of meso-carbon micro-beads (MCMBs) according to the same procedure used in Example 1. MCMB microbeads (Sample 3a) were supplied by China Steel Chemical Co. (Taiwan). This material has a density of about 2.14 g/cm³; a particle size of 25 microns; and an inter-planar distance of about 0.336 nm. After deep oxidation treatment, the inter-planar spacing in the resulting graphite oxide micro-beads is approximately 0.76 nm. Upon constrained expansion/exfoliation for 3 minutes at 200° C., the exfoliated carbon has inter-flake pores with a size of 3 nm-15 nm. Exfoliated carbon worms were then roll-pressed to obtain graphitic films.

### EXAMPLE 4

### Fluorination of Carbon Fibers to Produce Exfoliated Graphite and Flexible Graphene Sheets

A CF_{0.68} sample obtained in EXAMPLE 5 was exposed at 250° C. and 1 atmosphere to vapors of 1,4-dibromo-2-butene (BrH₂C—CH═.CH═CH₂Br) for 3 hours. It was found that two-thirds of the fluorine was lost from the graphite fluoride sample. It is speculated that 1,4-dibromo-2-butene actively reacts with graphite fluoride, removing fluorine from the graphite fluoride and forming bonds to carbon atoms in the graphite lattice. The resulting product (Sample 6A) is mixed halogenated graphite, likely a combination of graphite fluoride and graphite bromide. Some of powders were thermally exfoliated to obtain exfoliated carbon fibers, which were re-compressed to obtain flexible graphite sheets (fluorinated graphite sheets).

### EXAMPLE 5

### Fluorination of Graphite to Produce Exfoliated Graphite and Flexible Graphene Sheets

Natural graphite flakes, a sieve size of 200 to 250 mesh, were heated in vacuum (under less than 10⁻² mmHg) for about 2 hours to remove the residual moisture contained in the graphite. Fluorine gas was introduced into a reactor and the reaction was allowed to proceed at 375° C. for 120 hours while maintaining the fluorine pressure at 200 mmHg. This was based on the procedure suggested by Watanabe, et al. disclosed in U.S. Pat. No. 4,139,474. The powder product obtained was black in color. The fluorine content of the product was measured as follows: The product was burnt according to the oxygen flask combustion method and the fluorine was absorbed into water as hydrogen fluoride. The amount of fluorine was determined by employing a fluorine ion electrode. From the result, we obtained a GF (Sample 5A) having an empirical formula (CF₀₇₅)ₙ. X-ray diffraction indicated a major (002) peak at 2θ=13.5 degrees, corresponding to an inter-planar spacing of 6.25 Å. Some of the graphite fluoride powder was thermally exfoliated to form graphite worms, which were air jet-milled to obtain expanded graphite flakes. The expanded graphite flakes were then compressed into graphitic sheets.

### EXAMPLE 6

### Preparation of Polybenzoxazole (PBO) Films, Graphene-PBO Films, And Expanded Graphite Flake-PBO Films (followed by Carbonization/Graphitization to Produce Pyrolytic Films)

Polybenzoxazole (PBO) films were prepared via casting and thermal conversion from its precursor, methoxy-containing polyaramide (MeO-PA). Specifically, monomers of 4, 4′-diamino-3,3′-dimethoxydiphenyl (DMOBPA), and isophthaloyl dichloride (IPC) were selected to synthesize PBO precursors, methoxy-containing polyaramide (MeO-PA) solution. This MeO-PA solution for casting was prepared by polycondensation of DMOBPA and IPC in DMAc solution in the presence of pyridine and LiCl at −5° C. for 2 hr, yielding a 20 wt % pale yellow transparent MeO-PA solution. The inherent viscosity of the resultant MeO-PA solution was 1.20 dL/g measured at a concentration of 0.50 g/dl at 25° C. This MeO-PA solution was diluted to a concentration of 15 wt % by DMAc for casting.

The as-synthesized MeO-PA was cast onto a glass surface to form thin films (35-120 μm) under a shearing condition. The cast film was dried in a vacuum oven at 100° C. for 4 hr to remove the residual solvent. Then, the resulting film with thickness of approximately 28-100 μm was treated at 200° C.-350° C. under N₂ atmosphere in three steps and annealed for about 2 hr at each step. This heat treatment serves to thermally convert MeO-PA into PBO films. For comparison, both graphene-PBO and expanded graphite flake-PBO films were made under similar conditions. The graphene or EP flake proportions were varied from 10% to 90% by weight.

All the films prepared were pressed between two plates of alumina while being heat-treated (carbonized) under a 3-sccm (standard cubic centimeters) argon gas flow in three steps: from room temperature to 600° C. in 1 h, from 600 to 1,000° C. in 1.5 h, and maintained at 1,000° C. for 1 h. The carbonized films were then roll-pressed in a pair of rollers to reduce the thickness by approximately 40%. The roll-pressed films were then subjected to graphitization treatments at 2,200° C. for 5 hours, followed by another round of roll-pressing to reduce the thickness by typically 20-40%.

The thermal conductivity values of a series of graphitic films derived from graphene-PBO films of various graphene weight fractions (from 0% to 100%) were measured. Significantly and unexpectedly, some thermal conductivity values are higher than those of both the film derived from PBO alone (860 W/mK) and the graphene paper derived from graphene sheets alone (645 W/mK). Quite interestingly, the neat PBO-derived graphitic films prepared under identical conditions exhibit a highest conductivity value of 860 W/mK, yet several combined graphene-PBO films, when carbonized and graphitized, exhibit thermal conductivity values of 924-1,145 W/mK.

The thermal conductivity values of a series of graphitic films derived from EP-PBO films of various weight fractions of expanded graphite flakes (EP, from 0% to 100%) were also obtained.

### EXAMPLE 7

### Preparation of Polyimide (PI) Films, Graphene-PI Films, and the Heat Treated versions thereof

The synthesis of conventional polyimide (PI) involved poly(amic acid) (PAA, Sigma Aldrich) formed from pyromellitic dianhydride (PMDA) and oxydianiline (ODA). Prior to use, both chemicals were dried in a vacuum oven at room temperature. Next, 4 g of the monomer ODA was dissolved into 21 g of DMF solution (99.8 wt %). This solution was stored at 5° C. before use. PMDA (4.4 g) was added, and the mixture was stirred for 30 min using a magnetic bar. Subsequently, the clear and viscous polymer solution was separated into four samples. Triethyl amine catalyst (TEA, Sigma Aldrich) with 0, 1, 3, and 5 wt % was then added into each sample to control the molecular weight. Stirring was maintained by a mechanical stirrer until the entire quantity of TEA was added. The as-synthesized PAA was kept at −5° C. to maintain properties essential for further processing.

Solvents utilized in the poly(amic acid) synthesis play a very important role. Common dipolar aprotic amide solvents utilized are DMF, DMAc, NMP and TMU. DMAc was utilized in the present study. The intermediate poly(amic acid) and NGP-PAA precursor composite were converted to the final polyimide by the thermal imidization route. Films were first cast on a glass substrate and then allowed to proceed through a thermal cycle with temperatures ranging from 100° C. to 350° C. The procedure entails heating the poly(amic acid) mixture to 100° C. and holding for one hour, heating from 100° C. to 200° C. and holding for one hour, heating from 200° C. to 300° C. and holding for one hour and slow cooling to room temperature from 300° C.

The PI films, pressed between two alumina plates, were heat-treated under a 3-sccm argon gas flow at 1000° C. This occurred in three steps: from room temperature to 600° C. in 1 h, from 600 to 1,000° C. in 1.3 h, and 1,000° C. maintained for 1 h.

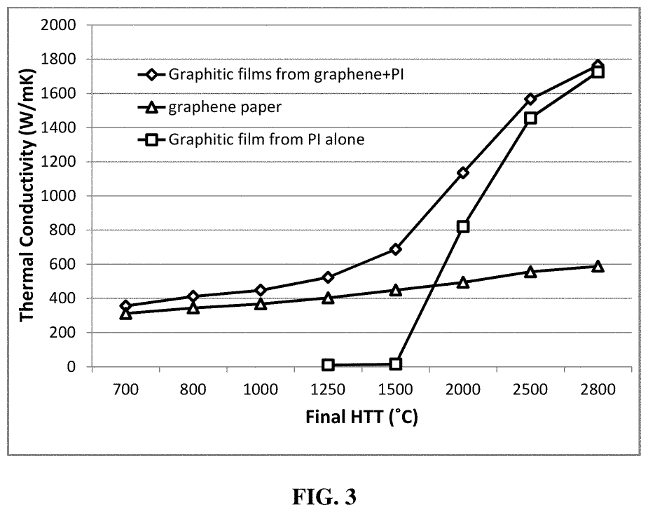

The thermal conductivity values of a series of graphitic films derived from graphene-PI films (66% graphene+34% PI), graphene paper alone, and PI film alone each prepared at various final heat treatment temperatures were measured and summarized in FIG. 3.

1. A cooling system for a battery module or pack comprising one or a plurality of battery cells, the system comprising a graphitic heat spreader element configured to be in thermal communication with the battery cells; and a cooling device in thermal communication with the graphitic heat spreader element and configured to transport heat generated from the battery cells through the graphitic heat spreader element to the cooling device when the battery cell is discharged, wherein the cooling device includes both a thermal interface portion and a cooling portion.

2. The cooling system of claim 1, further comprising a thermal interface material (TIM) coupled to at least one of the battery cells and the heat spreader element.

3. The cooling system of claim 1, wherein said graphitic heat spreader element is in a form of a film, sheet, layer, belt, or band having a thickness from about 100 nm to 10 mm.

4. The cooling system of claim 1, wherein said graphitic heat spreader element has a thermal conductivity no less than 200 W/mK.

5. The cooling system of claim 1, wherein said graphitic heat spreader element has a thermal conductivity no less than 1,000 W/mK.

6. The cooling system of claim 1, wherein said graphitic heat spreader element comprises a graphitic film selected from a flexible graphite sheet, an artificial graphite film, or a combination thereof.

7. The cooling system of claim 2, wherein said thermal interface material comprises a material selected from graphene sheets, graphene foam, graphene-containing paste, graphite flake-containing paste, graphene-containing polymer composite, flexible graphite sheet, artificial graphite film, particles of graphite, Ag, Ag, Cu, Al, brass, steel, Ti, Ni, Mg alloy, silicon nitride, boron nitride, aluminum nitride, boron arsenide, a composite thereof, or a combination thereof.

8. The cooling system of claim 2, wherein said thermal interface material is electrically insulating and thermally conducting, having a thermal conductivity no less than 1 W/mK.

9. The cooling system of claim 2, wherein said thermal interface material comprises a plastic or rubbery matrix composite containing graphene sheets, expanded graphite flakes, or a combination thereof.

10. The cooling system of claim 2, wherein said thermal interface material comprises a graphene foam having a thermal conductivity from 0.1 W/mK to 100 W/mK and said graphitic heat spreader element comprises an artificial graphite film having a thermal conductivity from 600 W/mK to 1,750 W/mK.

11. The cooling system of claim 1, wherein the cooling device is selected from a heat sink, a heat pipe, a vapor chamber, a stream of flowing fluid, a bath of a coolant fluid, a thermoelectric device, a heat exchanger, a cooled plate, a radiator, or a combination thereof.

12. The cooling system of claim 1, wherein the heat spreader element is in a heat-spreading relation to a surface of the battery cell and receives heat therefrom when the battery cell is discharged to power an external device.

13. The cooling system of claim 1, wherein the heat spreader element is configured to form multiple loading sites for accommodating individual battery cells.

14. The cooling system of claim 13, wherein said lodging sites comprise cylindrical pores to accommodate cylindrical-shape battery cells or rectangular pores to accommodate rectangular-shape battery cells.

15. The cooling system of claim 1, wherein the battery module comprises a lithium-ion battery, lithium metal secondary battery, lithium-sulfur battery, lithium-air battery, lithium-selenium battery, sodium-ion battery, sodium metal secondary battery, sodium-sulfur battery, sodium-air battery, magnesium-ion battery, magnesium metal battery, aluminum-ion battery, aluminum metal secondary battery, zinc-ion battery, zinc metal battery, zinc-air battery, nickel metal hydride battery, lead acid battery, lead acid-carbon battery, lead acid-based ultra-battery, lithium-ion capacitor, or supercapacitor.

16. A method of operating a battery cooling system, said method comprising: (a) bringing a graphitic heat spreader element in thermal contact with one or a plurality of battery cells in a module or pack to receive heat generated from the battery cells; and (b) directing the heat to transport through the graphitic heat spreader element to a cooling device which acts to remove the heat and keeps a battery temperature at or below a desired temperature.

17. The method of claim 16, wherein a thermal interface material is disposed between a surface of a battery cell and the graphitic heat spreader element.

18. The method of claim 16, wherein said graphitic heat spreader element has a thermal conductivity from 10 W/mK to 1,750 W/mK.

19. The method of claim 16, wherein said graphitic heat spreader element comprises a graphitic film selected from a flexible graphite sheet or an artificial graphite film obtained from carbonization and graphitization of a carbon precursor film.

20. The method of claim 17, wherein said thermal interface material comprises a material selected from graphene sheets, graphene foam, graphene-containing paste, graphite particle-containing paste, graphene-containing polymer composite, flexible graphite sheet, artificial graphite film, particles of Ag, Ag, Cu, Al, brass, steel, Ti, Ni, Mg alloy, silicon nitride, boron nitride, aluminum nitride, boron arsenide, a composite thereof, or a combination thereof.

21. The method of claim 16, wherein the cooling device is selected from a heat sink, a heat pipe, a vapor chamber, a stream of flowing fluid, a bath of a coolant fluid, a thermoelectric device, a cooled plate, a heat exchanger, a radiator, or a combination thereof.
